(19) United States
(12) Patent Application Publication
(10) Pub. No.: US 2021/0296061 A1
(43) Pub. Date: Sep. 23, 2021

(54) DAMPENED KEYCAPS

(71) Applicant: HEWLETT-PACKARD DEVELOPMENT COMPANY, L.P., SPRING, TX (US)

(72) Inventors: CHUNG-HUA KU, TAIPEI CITY (TW); CHI HAO CHANG, TAIPEI CITY (TW); KUAN-TING WU, TAIPEI CITY (TW)

(21) Appl. No.: 16/605,954

(22) PCT Filed: Jun. 26, 2017
(86) PCT No.: PCT/US2017/039227

§ 371 Date: Oct. 17, 2019

(51) Int. Cl. H01H 13/14; G06F 3/02; H01H 13/86; G05G 1/02

(52) U.S. Cl. CPC H01H 13/14; G06F 3/0202; H01H 2221/058; G05G 1/02; H01H 2221/062; H01H 13/86

(57) ABSTRACT

Example implementations relate to dampened keycaps. In an example, a dampened keycap includes a keycap, a link bar to contact the keycap, where the link bar includes a main body and an arm having a hooked portion forming a distal end of the link bar, and a dampening material disposed on a distal end of the link bar.

### BACKGROUND

Keyboards are utilized in a variety of applications. For example, keyboards may be utilized as an input device to provide letters, numbers and/or characters to an electronic device, among other possibilities. Examples of electronic devices having a keyboard include laptop computers, desktop computers, phones such as mobile phones, tablets, among other types of electronic devices.

### BRIEF DESCRIPTION OF THE DRAWINGS

FIG. 1 illustrates an exploded view of an example of a dampened keycap according to the disclosure.

FIG. 2 illustrates a view of an example of keyboard base plate including an example of a dampened keycap according to the disclosure.

FIG. 3 illustrates a portion of a section view of the example of the keyboard base plate in FIG. 2.

FIG. 4 illustrates a flow diagram of an example of a method of manufacture of a dampened keycap according to the disclosure.

### DETAILED DESCRIPTION

Operation of an electronic device including a keyboard with keycaps may cause mechanical components included in the keycaps to produce noise. For instance, actuation of keycaps may cause noise to be produced. For example, a keycap may be intentionally actuated with the expectation of causing an input to be received (i.e., depressing a particular keycap) or other a keycap may be unintentionally contacted for instance by direct contact with the keycap and/or by propagation of a force applied to another portion of the electronic device including the keycap. In any case, such contact may result in a keycap producing an undesired noise, for instance, a “rattling” sound. Moreover, operation of various electronic components such a fan and/or a speaker included in an electronic device may cause a keycap to move and/or experience a resonance noise. As a result, the keycap may produce an undesired noise. Regardless of the cause, such undesired noise may detract from a user's experience during use of an electronic device producing the undesired noise.

Accordingly, examples of the disclosure provide dampened keycaps, keyboard base plates including dampened keycaps, and methods of manufacture of dampened keycaps. As used herein, a dampened keycap refers to a keycap including a link bar with a dampening material disposed on a distal end of the link bar. Notably, the dampened keycaps and keyboard base plates including dampened keycaps provide less operational noise than those employing non-dampened keycaps while still maintaining a desired stability and performance (e.g., a desired force to fire) of keys of the keyboard base plate. More specifically, having dampening material disposed on the distal end of the link bar can mitigate or eliminate unintended movement of a keycap and thereby reduce or eliminate undesired noise produced by a keyboard. Keyboard base plates as used herein refer to those suitable in and/or as a keyboard.

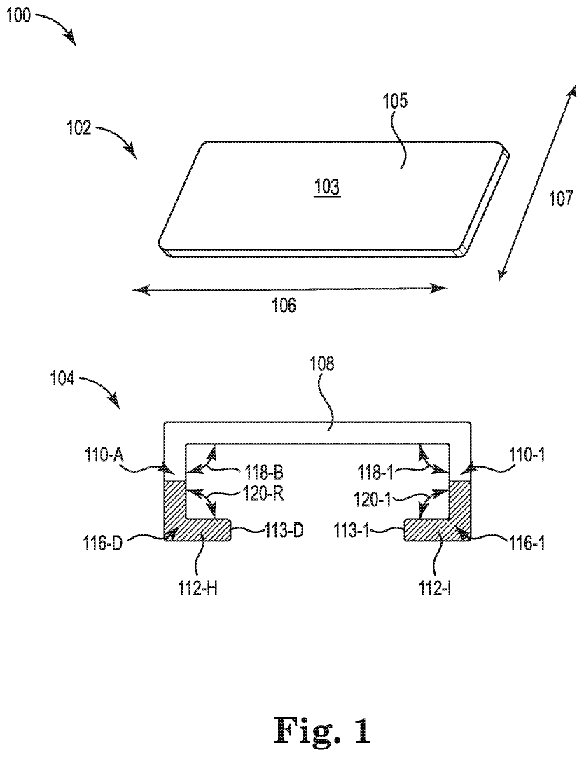

FIG. 1 illustrates an exploded view of an example of a dampened keycap 100 according to the disclosure. The dampened keycap 100 can include a keycap 102 and a link bar 104, among other possible components, such as a keyboard frame and/or a base layer, as described herein.

The keycap 102 can include a body 103 and protrusions (not shown for ease of illustration). The body 103 can be formed of plastic, metal, or combinations thereof. The body 103 has faces disposed between a top face 105 and a bottom face (not shown for ease of illustration) of the keycap 102. For example, the keycap 102 includes a total of four faces. However, a total number of the faces can be varied to include fewer or more faces. The keycap 102, while illustrated in FIG. 1 as being substantially a square shape can be various shapes such as circles, rectangles, etc. depending upon a desired application.

The body 103 can be in contact with and/or to contact a dome, as describe herein. The protrusions can extend from the body 103 of the keycap 102. For instance, the protrusion can extend from a bottom face (not shown) of the keycap to contact the link bar 104 and/or to contact a base layer. For example, the keycap 102 can be coupled to the base layer via insertion of a protrusion into a receptacle in the base layer, among other possibilities.

The protrusions can be formed of plastic, metal, or combinations thereof. In various examples, the protrusions can be integrated with the body 103 of the keycap 102 and formed of a same material (e.g., plastic) as the body 103 of the keycap 102. In some examples, each protrusion of the protrusions on the keycap 102 is formed of a tab integrated with the body 103 of the keycap 102. A total number of protrusions, a type of protrusion, a size of the protrusion, a position of a protrusion along a face of the keycap 102 or otherwise on the keycap 102, among other items can be varied depending upon a desired application.

The link bar 104 can include a main body 108 and an arm extending from the main body 108 such as a first arm 110-1 and/or a second arm 110-A. For instance, as illustrated in FIG. 1, the first arm 110-1 can extend from an end of the main body and the second arm 110-A can extend from an opposite end of the main body 108. While FIG. 1 illustrates the link bar 104 as including two arms (110-1 and 110-A) a total number arms and/or relative position on the arms can vary.

The main body 108, the first arm 110-1, and the second arm 110-A can each be formed of a particular material such as a metal, ceramic, plastic, or combinations thereof. In some examples, each of the main body 108, the first arm 110-1, and the second arm 110-A are formed of the same material. For instance, in some examples, main body 108, the first arm 110-1, and the second arm 110-A are formed of a metal. As illustrated in FIG. 1, the main body 108, the first arm 110-1 and the second arm 110-A can be coplanar and continuous (e.g., formed of a continuous metal material).

In some examples, first arm 110-1 and the second arm 110-A are each at a substantially ninety-degree angle, represented by a first angle 118-1 and a second angle 118-B, respectively, to the main body 108 and are coplanar to the main body 108. However, other angles of an arm relative to the main body 108 (which may or may not be coplanar with the arm) are possible. For instance, an angle of the first arm 110-1 and/or the second arm 110-A relative to the main body can be varied to provide an angle other than a substantially ninety-degree angle (e.g., a thirty-degree angle, a forty-five-degree angle, and/or a sixty-degree angle, among other possible angles).

As illustrated in FIG. 1, the link bar 104 can include an arm such as the first arm 110-1 having a first hooked portion 112-1 forming a first distal end 113-1 of the link bar 104. Similarly, the second arm 110-A can have a second hooked portion 112-H forming a second distal end 113-D of the link bar 104. The first and second hooked portions can be coplanar and continuous with the other portions (e.g., the main body 108, the first arm 110-1, and/or the second arm 110-A) of the link bar 104. For instance, as illustrated in FIG. 1, each of the main body 108, the first arm 110-1, the second arm 110-A, the first hooked portion 112-1, and the second hooked portion 112-H are continuous and coplanar (along a first direction 106 and a second direction 107).

In some examples, first hooked portion 112-1 and the second hooked portion 112-H are each at a substantially ninety-degree angle, represented by a third angle 120-1 and a fourth angle 120-R, respectively, to the first arm 110-1 and the second arm 110-A. Having the first hooked portion 112-1 and the second hooked portion 112-H are each at a substantially ninety-degree angle may promote coupling of the link bar 104 to a base layer. However, other angles of a hooked portion relative to the main body 108 and/or relative to an arm are possible to provide an angle other than a substantially ninety-degree angle (e.g., a thirty-degree angle, a forty-five-degree angle, and/or a sixty degree angle, among other possible angles).

The link bar 104 can be disposed between the keycap and a base layer, as described herein. It is understood the link bar 104 can be coupled to or in contact with the keycap 102 in a variety of manners including those described herein. Similarly, the link bar 104 can be coupled to (e.g., directly coupled to) or in contact with a base layer (not illustrated in FIG. 1) in a variety of manners including those described herein.

In some examples, the link bar 104 can be a balance bar. For instance, the link bar 104 can act as a balance bar for keys of longer width, such as the “space” key and the “shift” key, which may utilize additional structure to balance the force exerted on either end of the key. The additional structure can include protrusions extending from the keycap to contact the link bar 104 in at least two different locations (e.g., including respective locations near or at opposing distal ends of the link bar 104), among other possibilities. In this manner, the link bar 104 can be disposed under the key cap 102 to balance a force exerted on the end of the cap across the width of the key. As such, the keycap 102 may be levelly depressed downwardly even when the force is exerted on a particular end of the keycap 102 (but not on the opposing end of the keycap).

In various examples, a dampening material can be disposed on a distal end of the link bar 104. As used herein, a dampening material refers to a non-metallic material suitable to promote aspects of dampened keycaps, as described herein. Examples of suitable dampening materials include comprises styrenic block copolymers, thermoplastic olefins, thermoplastic polyurethanes, thermoplastic copolyester, thermoplastic polyamides, thermoplastic polyether block amides, thermoplastic vulcanisates, silicone rubber, thermoplastic elastomers, thermoplastic rubber, or combinations thereof.

As illustrated in FIG. 1, dampening material can be disposed on a respective distal end of each arm of the arms extending from the main body 108. Stated differently, dampening material illustrated as first dampening material 116-1 and a second dampening material 116-D can be disposed on the first hooked portion 112-1 of the first arm 110-1 and on the second hooked portion 112-H of the second arm 110-A and a respective distal end of each arm of the arms extending from the main body 108. While illustrated as having dampening material on each arm 110-1, 110-A of the link bar 104 and extending from a hooked portion to a portion of an arm other configurations are possible. For instance, dampening material may be disposed on some but not all arms of a link bar.

Moreover, a relative portion of the link bar having the dampening material disposed thereon can be varied. For instance, in some examples dampening material may be disposed on a hooked portion but not on an arm (e.g., arm 110-A) and/or not on a main body 108. For example, each of the main body 108 and an arm such as the first arm 110-1 and/or the second arm 110-A can be without any dampening material disposed thereon. In such examples, dampening material can be disposed on a distal end of the link bar 104 such as the first distal end 113-1 and/or 113-D but again does not extend beyond a hooked portion such as the first hooked portion 112-1 and/or the second hook portion 112-H. As used herein, the hooked portion refers to a portion of the link bar 104 which is at an angle (e.g., the third angle 120-1 and/or the fourth angle 120-R) relative to a main body and an arm.

The dampen material can be disposed on the distal end of the link bar around a perimeter such as an entire circumference of a distal end and/or a hooked portion of the link bar 104. For instances, in some examples, the dampening material extends continuously from the distal end (e.g., the first distal end 113-1 and the second distal end 113-D) of the link bar 104 over at least a portion of an exterior surface of the arm (e.g., the first arm 110-1 and the second arm 110-A), as illustrated in FIG. 1. The dampening material can be disposed over a varying thickness or a constant thickness at different portions of the link bar 104.

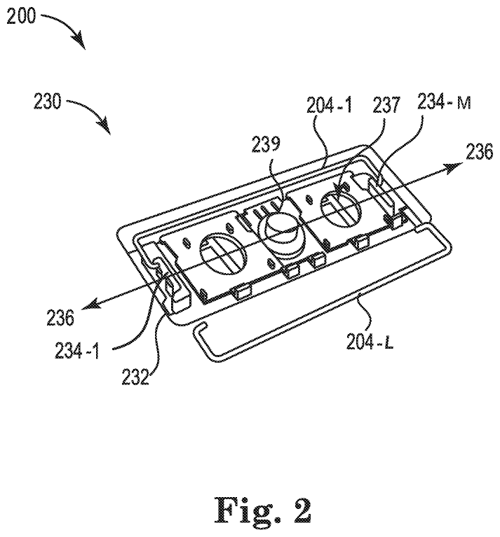

FIG. 2 illustrates a view of an example of keyboard base plate 230 including an example of a dampened keycap 200 according to the disclosure. Keycaps, portions of key mechanisms, key guides, electrical bridges, etc. have been omitted from FIG. 2 for ease of illustration. As illustrated in FIG. 2, the keyboard base plate 230 can include the dampened keycap 200 (keycap not shown in FIG. 2 for ease of illustration) including a link bar such as a link bar 204-1 and/or link bar 204-L (referred to herein as link bar “204”). While illustrated as including two distinct link bars, the dampened keycap 200 can include more or fewer link bars. The keyboard base plate 230 can include a dome 239. The dome 239 can be formed of a resilient material such as a rubber, among other possibilities. As mentioned, a keycap (not shown) be in contact with and/or to contact the dome 239.

In various examples, the keyboard base plate 230 can include a base layer 232. Base layer 232 can be formed of a metal, ceramic, plastic, or combinations thereof. For instance, in some examples, base layer 232 is formed of a metal. Examples of suitable metals include aluminum, steel, copper, titanium, tungsten, or combinations thereof. While described herein as having the base layer 232 included in the keyboard base plate 230 other configurations are possible. For instance, the keyboard base plate can be without a base layer and instead couple to a base layer included in an electronic device or otherwise provided separately from the keyboard base plate 230.

In any case, the base layer 232 can include a mounting point 234. As used herein, a mounting point refers to a mechanism to permit the base layer 232 to couple to the link bar 204-1. Link bar 204-1 is illustrated as coupled to the mounting point 234-1. While link bar 204-L is illustrated in a decoupled state can be coupled to a mounting point such as the first mounting point 234-1 and the second mounting point 234-M. In some examples, the mounting point 234 is in the form a protrusion extending from the base layer 232 and including an opening to receive the link bar 204, as illustrated in FIG. 2. For instance, the mounting point 234 can include a first mounting point 234-1 including a first opening (not shown in FIG. 2 for ease of illustration) and a second mounting point 234-M including a second opening (not shown in FIG. 2 for ease of illustration) to receive respective distal ends of the link bar 204, as illustrated in FIG. 2. The first opening and the second opening can extend at least partially (e.g., entirely) through the first mounting point 234-1 and the second mounting point 234-M, respectively, along an axis that is substantially coplanar with cross-section 236.

In some examples, dampening material can be directly coupled to a mounting point. For example, the first dampening material 113-1 can be directly coupled to the first mounting point 234-1 and/or the second dampening material 113-D can be directly coupled to the second mounting point 234-M. In some examples, each of the first dampening material 113-1 and the second dampening material 113-D are directly coupled to the first mounting point 234-1 and the second mounting point 234-M, respectively. Notably, such direct coupling of the dampening material to a mounting point can mitigate or eliminate undesired noise (e.g., bumping noise, rattle noise, and/or resonance noise) in contrast to other approaches such as other approaches that merely use a spacer of other material on a portion of a link bar such as an arm of the link bar but do not include dampening material on a distal end of a link bar.

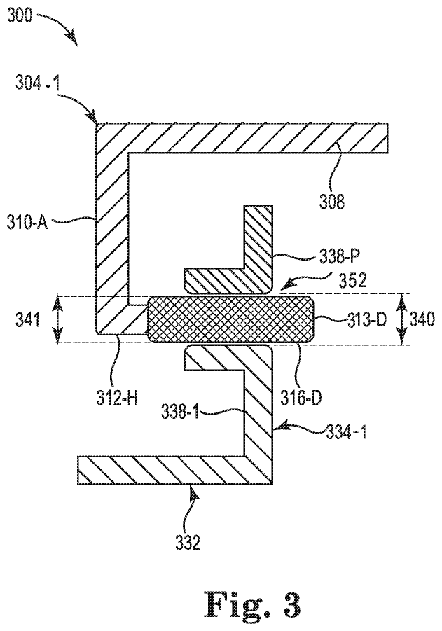

FIG. 3 illustrates a portion of a section view (taken along cross-section 236 of FIG. 2) of the example of the keyboard base plate in FIG. 2. As illustrated in FIG. 3, the dampened keycap 300 can include a link bar 304-1. Link bar 304-1 is analogous to link bar 104 and link bar 204 illustrated in FIGS. 1 and 2, respectively. The link bar 304-1 can include a main body 308 and an arm such as 310-A having a hooked portion such as hooked portion 312-H forming a distal end such as a second distal end 316-D of the link bar 304-1.

The dampened keycap 300 can be coupled to a base layer 332. For instance, the base layer 332 can include a mounting point such as the first mounting point 334-1 to facilitate coupling the link bar 304-1 to the base layer 332. In various examples, the link bar 304-1 can be coupled to a mounting point such as the first mounting point 334-1 including a first opening 352 between a first mounting portion 338-1 and a second mounting portion 338-P of the first mounting point 334-1. That is, the first mounting portion 338-1 and the second mounting portion 338-P can define at least a portion of a first opening in the first mounting point 334-1.

For instance, the second distal end 316-D of the link bar 304-1 can be inserted into the first opening 352 to couple the link bar 304-1 to the first mounting point, as illustrated in FIG. 3. In the same or similar manner, the first distal end of the link bar 304-1 can be inserted into the second opening in the second mounting point (not illustrated in FIG. 3) to couple the link bar via the first mounting point and the second mounting point to the base layer 332. As illustrated in FIG. 3, a diameter 340 of the first opening 352 can be substantially equal to a diameter 341 of a distal end such as the second distal end 316-D of the link bar 304-1 to readily facilitate coupling, for instance via a friction fit, the link bar 304-1 to a mounting point such as the first mounting point 334-1. As illustrated in FIG. 3, an overall diameter of a distal end of the link bar 304-1 having a dampening material disposed thereof is greater than a diameter of the link bar 304-1 at other portions where dampening material is not present.

As mentioned, a dampening material such as a second dampening material 316-D can be disposed on the second distal end 316-D of the link bar to promote aspects of dampened keycaps. For instance, the second dampening material 316-D can be directly coupled to the first mounting point 334-1 to mitigate or eliminate undesired noise (e.g., bumping noise, rattle noise, and/or resonance noise). That is, as illustrated in FIG. 3, the dampening material such as the second dampening material 316-D can extend around an entire circumference (as is shown collectively from the view in FIG. 3 in combination with the view of FIG. 1 of the dampening material) of a portion of the link bar 304-1 on which the dampening material is disposed, among other possibilities.

As mentioned, in some examples, each of the main body 308 and an arm such as the second arm 310-A can be without any dampening material disposed thereon, as illustrated in FIG. 3. That is, in such examples, dampening material can be disposed on a distal end of the link bar 304-1 such as the first distal end 313-D (illustrated as being overlaid with dampening material) but again does not extend beyond a hooked portion such as the second hook portion 312-H.

However, while FIG. 3 illustrates the keyboard base plate as including a particular number of elements, the disclosure is not so limited. Elements shown in the various figures herein can be added, exchanged, and/or eliminated so as to promote various aspects of dampened keycaps according to the disclosure. For example, while not illustrated in FIG. 3, a first distal end of the link bar 304-1 can be coupled to a mounting point, via a first dampening material, to mitigate or eliminate undesired noise.

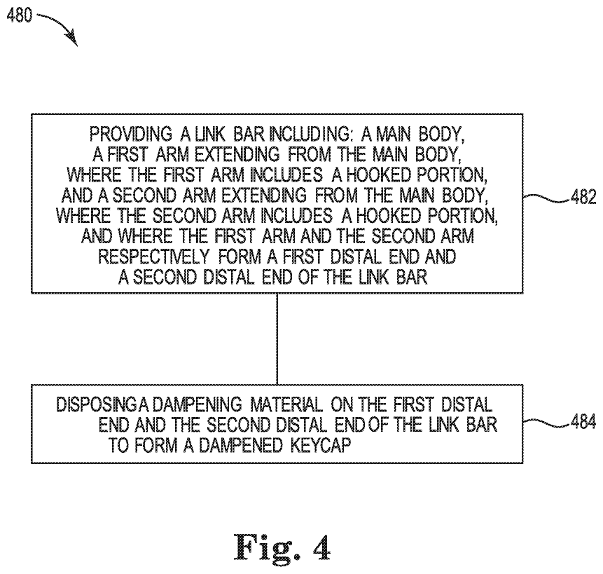

FIG. 4 illustrates a flow diagram of an example of a method 480 of manufacture of a dampened keycap according to the disclosure. As illustrated at 482, the method 480 can include providing a link bar including a main body, a first arm extending from the main body, where the first arm includes a hooked portion, and a second arm extending from the main body, where the second arm includes a hooked portion, and where the first arm and the second arm respectively form a first distal end and a second distal end of the link bar. Providing can include manufacture of or otherwise procuring the link bar.

As illustrated at 484, the method 480 can include disposing a dampening material on the first distal end and the second distal end to form a dampened keycap. Disposing refers to directly or indirectly causing each dampening material to contact a link bar. For instance, in some examples, disposing the dampening material can include insert molding the dampening material on the first distal end and the second distal end of the link bar. However, the disclosure is not so limited. Rather, the dampening material can be overmolded, insert molded, or otherwise coupled to the link bar.

It will be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

In the foregoing detailed description of the disclosure, reference is made to the accompanying drawings that form a part hereof, and in which is shown by way of illustration how examples of the disclosure may be practiced. These examples are described in sufficient detail to enable those in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing, For example, reference numeral 104 may refer to element 104 in FIG. 1 and an analogous element is identified by reference numeral 204 in FIG. 2. Elements shown in the various figures herein can be added, exchanged, and/or eliminated to provide additional examples of the disclosure. The proportion and the relative scale of the elements provided in the figures are intended to illustrate the examples of the disclosure, and should not be taken in a limiting sense. Further still, while some elements are designated as a “top face” or a “bottom face” those in the art will recognize that such elements may correspond to other relative terms or possible orientations in some applications to practice the examples of this disclosure.

What is claimed:

1. A dampened keycap, comprising:
a keycap;
a link bar to contact the keycap, wherein the link bar includes a main body and an arm having a hooked portion forming a distal end of the link bar; and
a dampening material disposed on a distal end of the link bar.

2. The keycap of claim 1, wherein the link bar further comprises:
a first arm extending from the main body; and
a second arm extending from the main body, wherein the second arm extends for an opposite end of the main body.

2. The keycap of claim 2, wherein the dampening material is disposed on:
a first distal end of the first arm; and
a second distal end of the second arm.

4. The keycap of claim 2, wherein the main body, the first arm, and the second arm are coplanar.

5. The keycap of claim 3, wherein the main body, the first arm, and the second arm are continuous.

6. The keycap of claim 1, wherein the dampening material is disposed on the distal end of the link bar around an entire circumference of the distal end of the link bar.

7. The keycap of claim 1, wherein the dampening material extends continuously from the distal end of the link bar over a portion of an exterior surface of the arm.

8. The keycap of claim 1, wherein the link bar further comprises a metal, and wherein the dampening material further comprises styrenic block copolymers, thermoplastic olefins, thermoplastic polyurethanes, thermoplastic copolyester, thermoplastic polyamides, thermoplastic polyether block amides, thermoplastic vulcanisates, silicone rubber, thermoplastic elastomers, thermoplastic rubber, or combinations thereof.

9. A keyboard base plate, comprising:
a base layer including a first mounting point and a second mounting point;
a dampened keycap comprising a link bar to couple to the mounting point of the base layer, the link bar further comprising:
a main body;
a first arm extending from the main body, wherein the first arm includes a hooked portion;
a second arm extending form the main body, wherein the second arm includes a hooked portion, and wherein the first arm and the second arm respectively form a first distal end and a second distal end of the link bar; and
a dampening material disposed on the first distal end and the second distal end of the link bar to couple, via the dampening material, the first distal end and the second distal end to the mounting point.

10. The keyboard base plate of claim 9, wherein the dampening material is directly coupled to the mounting point.

11. The keyboard base plate of claim 9, wherein the mount further comprises a protrusion extending from the base layer and defining an opening to receive the first distal end or the second distal end of link bar.

12. The keyboard base plate of claim 9, wherein the link bar further comprises a balance bar to contact the keycap at a plurality of locations.

13. The keyboard base plate of claim 9, wherein the first mounting point and the second mounting point each comprise a mounting point including an opening to receive the link bar, and wherein the first mounting point and the second mounting point each further comprise a metal mounting point.

14. A method, comprising:
providing a link bar including:
a main body;
a first arm extending from the main body, wherein the first arm includes a hooked portion; and
a second arm extending from the main body, wherein the second arm includes a hooked portion, and wherein the first arm and the second arm respectively form a first distal end and a second distal end of the link bar; and
disposing a dampening material on the first distal end and the second distal end of the link bar to form a dampened keycap.

15. The method of claim 14, wherein disposing further comprises insert molding the dampening material on the first distal end and the second distal end.
